(19) United States
(12) Patent Application Publication
(10) Pub. No.: US 2019/0114759 A1
(43) Pub. Date: Apr. 18, 2019

(54) INSPECTION APPARATUS, IMAGE FORMING APPARATUS, AND RECORDING MEDIUM

(71) Applicant: Konica Minolta, Inc., Tokyo (JP)

(72) Inventor: Mitsuo Azumai, Tokyo (JP)

(73) Assignee: Konica Minolta, Inc., Tokyo (JP)

(21) Appl. No.: 16/160,731

(22) Filed: Oct. 15, 2018

(30) Foreign Application Priority Data
Oct. 13, 2017 (JP) 2017-199477
Aug. 10, 2018 (JP) 2018-151128

(51) Int. Cl. G06T 7/00; G01N 21/88; G06T 7/73

(52) U.S. Cl. CPC G06T 7/001; G01N 21/8851; G06T 2207/30124; G01N 2021/8887; G06T 7/74

(57) ABSTRACT

An inspection apparatus that handles a printed material in which an image is formed on a sheet by a pulse width modulation (PWM) signal having a pulse width according to a pixel value of each pixel of original image data, the inspection apparatus includes: a reference image generator that samples the PWM signal and generates the reference image data that serve as a criterion as a comparison target in inspection; and an inspector that inspects the printed material by comparing read image data obtained by reading the printed material and the reference image data.

### CROSS-REFERENCE TO RELATED APPLICATION

The entire disclosure of Japanese patent Application No. 2017-199477, filed on Oct. 13, 2017, is incorporated herein by reference in its entirety.

### BACKGROUND

### Technical Field

The present invention relates to an inspection apparatus, an image forming apparatus, and a recording medium capable of quickly and appropriately conducting inspection by comparing read image data and reference image data at the time of image formation.

### Description of the Related art

In recent years, there has been a demand for stability against printed materials and there has been a demand for a mechanism that accurately finds faults, abnormalities, and defects of printed materials at an early stage and ensures such printed materials do not leak to the market.

To cope with these demands, there is a technology of reading an image of a printed material and comparing the image that has been read with a reference image to inspect the image of the printed material.

In particular, when different letters and images are formed on each sheet as in variable printing, it is necessary to quickly execute this inspection and identify an abnormal printed material.

Various proposals have also been made by JP 5953866 B2 with respect to inspection of an abnormality in a printed material.

In JP 5953866 B2, an image is formed using original image data to create a printed material such that this printed material is read by a scanner to generate read image data and inspection is conducted by comparing reference image data created from the original image data with the read image data.

Generally, the resolution of the read image data is lower than that of the original image data in many cases. This is because it takes time to compare images on a pixel-by-pixel basis and accordingly resolution is deliberately lowered to decrease the number of times of comparison on a pixel-by-pixel basis and reduce processing time.

Therefore, when the reference image data is generated from the original image data, an image process for resolution conversion is usually expected. For example, in a case where the original image data has 600 dpi and the reading resolution of the scanner is 300 dpi, a resolution conversion process to convert 600 dpi into 300 dpi is usually expected when the reference image data is generated.

Since this image process for resolution conversion is a two-dimensional image process, high cost is incurred if the process is executed by hardware, although high speed processing is realized. On the other hand, if the process is executed by software, longer processing time is required, while cost is satisfactory.

Generally, the image process for resolution conversion is frequently executed through software processing, but in this case, since the generation of image data for reference is delayed due to a longer processing time, there is a difficulty in implementing inspection (comparison between the read image data and the image data for reference) in real time. As a result, it becomes difficult to find an abnormal printed material at an early stage.

In addition, when an abnormality is discovered in the inspection result, it is difficult to identify whether an image former has a problem in exposure, transfer, and the like for generating a printed material, or the image process for resolution conversion for generating the image data for reference has a problem.

### SUMMARY

An inspection apparatus, an image forming apparatus, and a recording medium storing an inspection program according to one or more embodiments of the present invention can quickly and appropriately conduct inspection by comparing read image data and reference image data at the time of image formation and identify a source of a problem.

According to one or more embodiments of the present invention, there is provided an inspection apparatus that handles a printed material in which an image is formed on a sheet by a pulse width modulation (PWM) signal having a pulse width according to a pixel value of each pixel of original image data, to inspect the printed material by comparing read image data obtained by reading the printed material and reference image data serving as a criterion as a comparison target in inspection, the inspection apparatus including: a reference image generator that samples the PWM signal and generates the reference image data; and an inspector that inspects the printed material by comparing the read image data and the reference image data.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram illustrating a configuration of one or more embodiments of the invention;

FIG. 2 is a configuration diagram illustrating a configuration of one or more embodiments of the invention;

FIG. 3 is a configuration diagram illustrating a configuration of one or more embodiments of the invention;

FIG. 4 is a configuration diagram illustrating a configuration of one or more embodiments of the invention;

FIG. 5 is a flowchart illustrating an example of a process of one or more embodiments of the invention;

FIGS. 6A to 6G are explanatory diagrams illustrating an example of process timings according to one or more embodiments of the invention;

FIGS. 7A to 7G are explanatory diagrams illustrating an example of process timings according to one or more embodiments of the invention;

FIG. 8 is a configuration diagram illustrating a configuration of one or more embodiments of the invention;

FIG. 9 is a flowchart illustrating another example of a process of one or more embodiments of the invention;

FIG. 10 is a configuration diagram illustrating another configuration of one or more embodiments of the invention;

FIGS. 11A1 to 11G are explanatory diagrams illustrating sheet bundles used in another configuration of one or more embodiments of the invention;

FIG. 12 is a flowchart illustrating another example of a process of one or more embodiments of the invention;

FIG. 13 is an explanatory diagram illustrating another example of an aspect of a process of one or more embodiments of the invention;

FIG. 14 is an explanatory diagram illustrating another example of an aspect of a process of one or more embodiments of the invention; and

FIG. 15 is an explanatory diagram illustrating an example of a configuration of an inspection apparatus as a comparative example.

### DETAILED DESCRIPTION

Hereinafter, embodiments of the present invention will be described with reference to the drawings. However, the scope of the invention is not limited to the disclosed embodiments.

Hereinafter, with reference to the drawings, a detailed description will be given of the embodiments of an inspection apparatus, an image forming apparatus, and a recording medium storing an inspection program capable of avoiding a defective printed material from being delivered in the end and suppressing downtime of image formation even when a fault and an abnormality on printed materials continue.

[Configuration (1)]

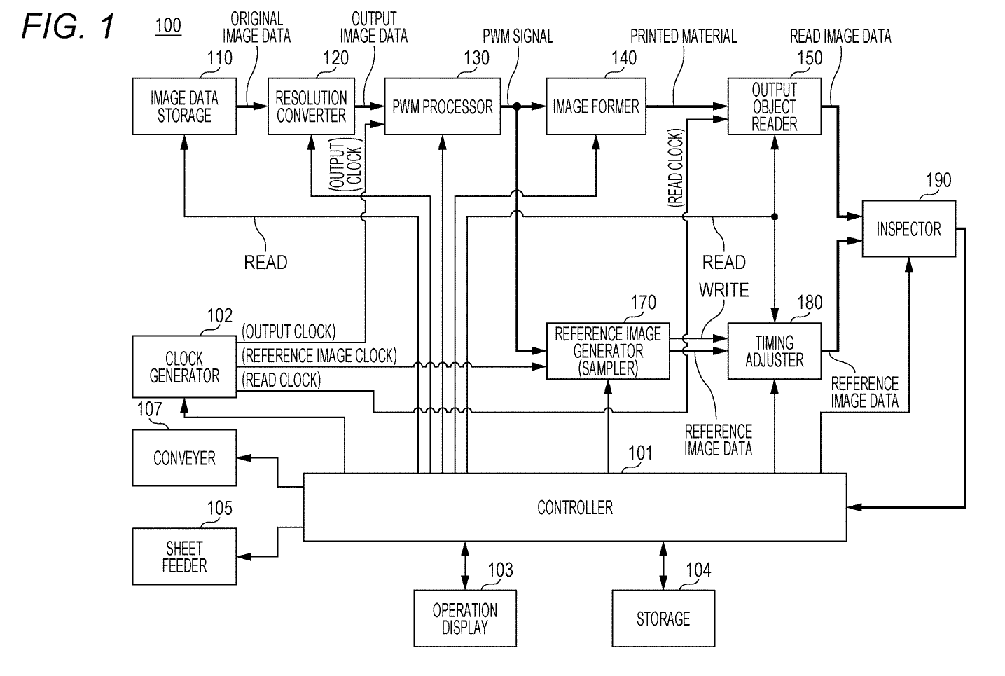

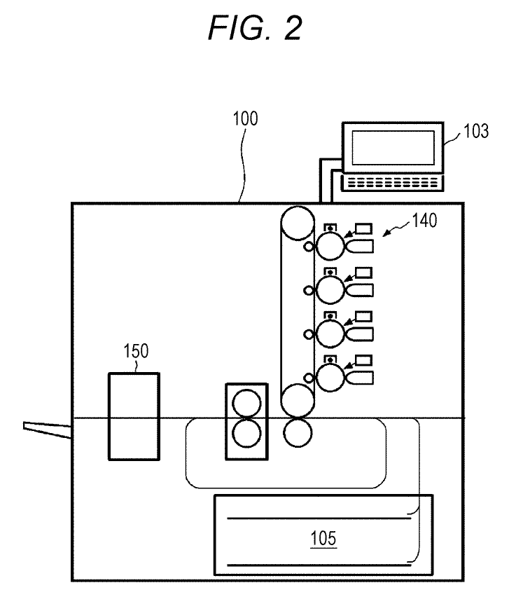

A first configuration example of the image forming apparatus 100 including the inspection apparatus will be described in detail with reference to FIGS. 1 and 2. FIG. 1 is a functional block diagram illustrating the function of each member of each apparatus included in the image forming apparatus 100. FIG. 2 is an explanatory diagram illustrating mechanical constituent elements of each member of each apparatus included in the image forming apparatus 100.

The image forming apparatus 100 is constituted by a controller 101, a clock generator 102, an operation display 103, a storage 104, a sheet feeder 105, a conveyer 107, an image data storage 110, a resolution converter 120, a PWM processor 130, an image former 140, an output object reader 150, a reference image generator 170, a timing adjuster 180, and an inspector 190 included therein. The controller 101 controls each member in the image forming apparatus 100. The clock generator 102 generates a timing signal and a clock signal required for processes in each member. The operation display 103 accepts operation input by a user and displays the status of the image forming apparatus 100. The storage 104 stores various settings. The sheet feeder 105 is capable of feeding a sheet accommodated in a sheet feeding tray. The conveyer 107 conveys a sheet in the image forming apparatus. The image data storage 110 stores original image data for image formation. The resolution converter 120 converts the original image data into output image data having a resolution necessary for image formation. The PWM processor 130 converts output data into a PWM signal having a pulse width according to a pixel value of each pixel in a state usable in the image former. The image former 140 forms an image on a sheet based on the PWM signal to create a printed material. The output object reader 150 reads the generated printed material being conveyed. The reference image generator 170 samples the PWM signal at a predetermined cycle to generate reference image data having a resolution having a predetermined relationship with a resolution of the read image data. The timing adjuster 180 delays an arrival timing of the reference image data to the inspector to make timings of the read image data and the reference image data coincide with each other. The inspector 190 compares the read image data and the reference image data to inspect the printed material and notifies the controller 101 of an inspection result.

As illustrated in FIG. 2, the image former 140 is a so-called electrophotographic image former in which an electrostatic latent image formed on a charged image carrier is developed into a toner image and the toner images of respective colors are superimposed on an intermediate transfer member to then be transferred onto a sheet. However, the specific configuration of the image former 140 is not limited to the configuration illustrated in FIG. 2. In addition, as illustrated in FIG. 2, the output object reader 150 is disposed on the downstream side of the image former 140 and may read both sides of the printed material at one time or may read one side of the printed material each time. In addition, the reference image data having the resolution having the predetermined relationship with the resolution of the read image data, generated by the reference image generator 170 corresponds to a case where the resolution is equal to that of the read image data, a case where the resolution is an integral multiple or 1/integer of the resolution of the read image data, and the like. That is, the resolution of the reference image data corresponds to the resolution of the read image data.

[Configuration (2)]

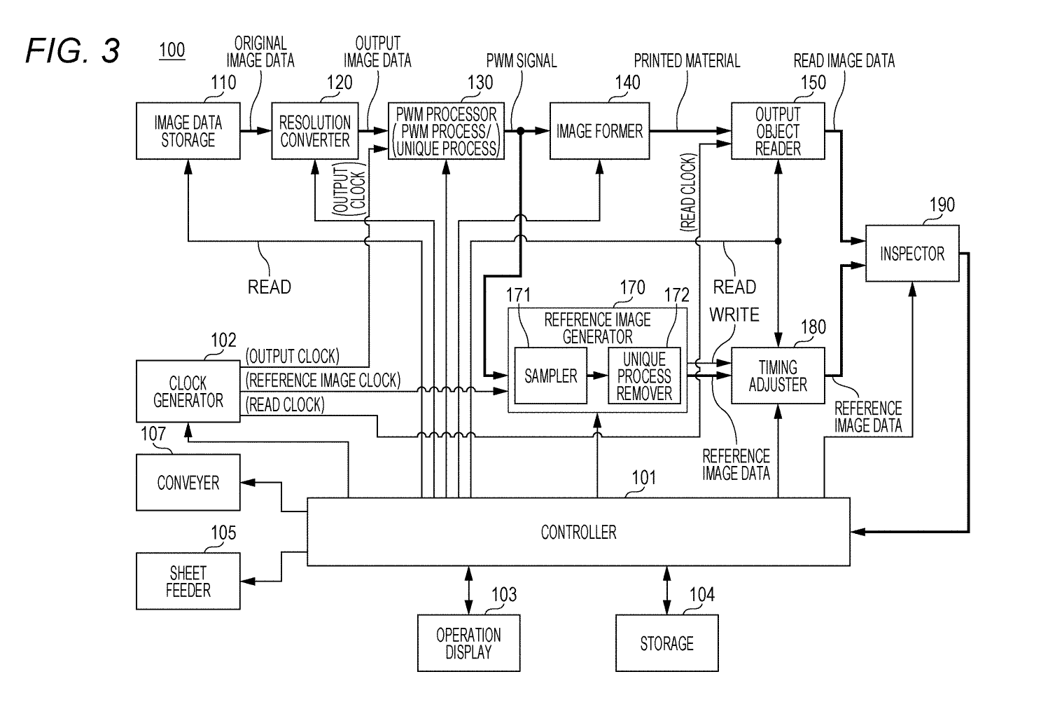

A second configuration example of the image forming apparatus 100 including the inspection apparatus will be described in detail with reference to FIG. 3. FIG. 3 is a functional block diagram illustrating the function of each member of each apparatus included in the image forming apparatus 100. In this second configuration example of the image forming apparatus 100, the same components as those in the first configuration example illustrated in FIG. 1 are denoted by the same reference numerals and redundant description will be omitted.

In FIG. 3, the PWM processor 130 executes a unique image process in addition to the PWM process. This unique image process is a process of thickening a thin line in advance in order to deal with, for example, a phenomenon in which a thin line is made thinner in electrophotographic image formation in the image former 140. With this process, the phenomenon in which a thin line is made thinner does not appear on the printed material.

Additionally, the reference image generator 170 is constituted by a sampler 171 that samples the PWM signal at a predetermined cycle to generate the reference image data having a resolution having a predetermined relationship with a resolution of the read image data, as well as a unique process remover 172 for removing an influence of the unique image process by the PWM processor 130 and generating reference image data in an initial state. With this configuration, a reference image is put into a normal state in which the unique image process has not been carried out and an appropriate comparison can be made between the read image and the reference image.

[Configuration (3)]

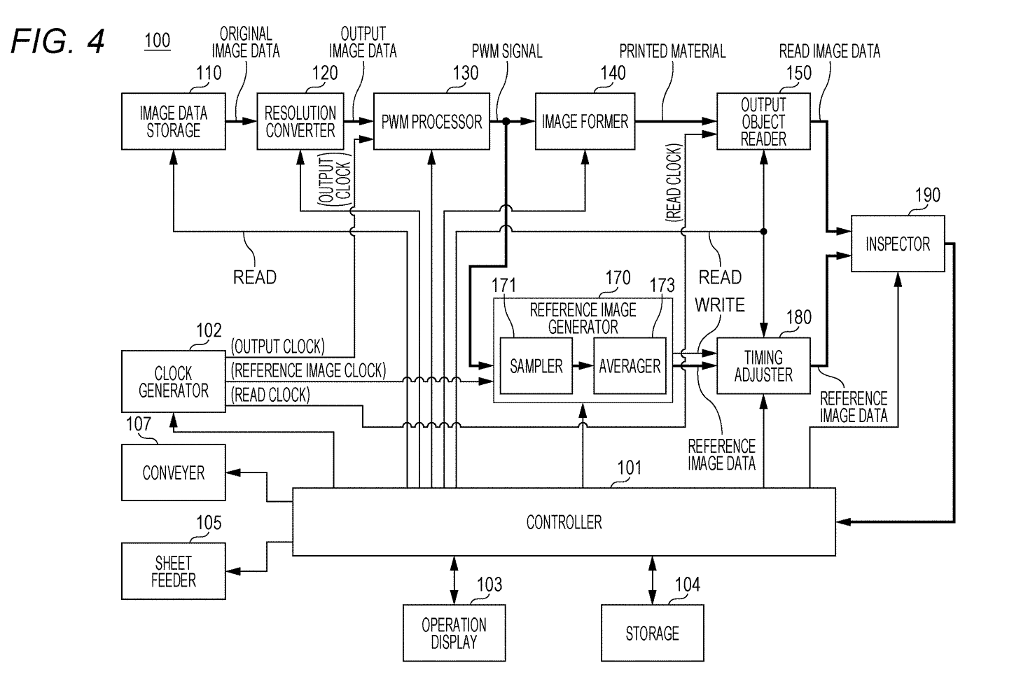

A third configuration example of the image forming apparatus 100 including the inspection apparatus will be described in detail with reference to FIG. 4. FIG. 4 is a functional block diagram illustrating the function of each member of each apparatus included in the image forming apparatus 100. In this third configuration example of the image forming apparatus 100, the same components as those in the first configuration example illustrated in FIG. 1 are denoted by the same reference numerals and redundant description will be omitted.

The reference image generator 170 is constituted by a sampler 171 that samples the PWM signal at a predetermined cycle to generate the reference image data having a resolution having a predetermined relationship with a resolution of the read image data, as well as an averager 173 that averages data obtained by sampling on a predetermined number basis.

In this case, the sampler 171 samples a PWM signal with binary values of ON and OFF a plurality of times at every predetermined cycle and uses a plurality of sampling results to generate the reference image data as multivalued data having a resolution having a predetermined relationship with the resolution of the read image data. Also in this case, as in the case of the configuration (2), the configuration for removing an influence of the unique image process may be equipped as well.

[Action]

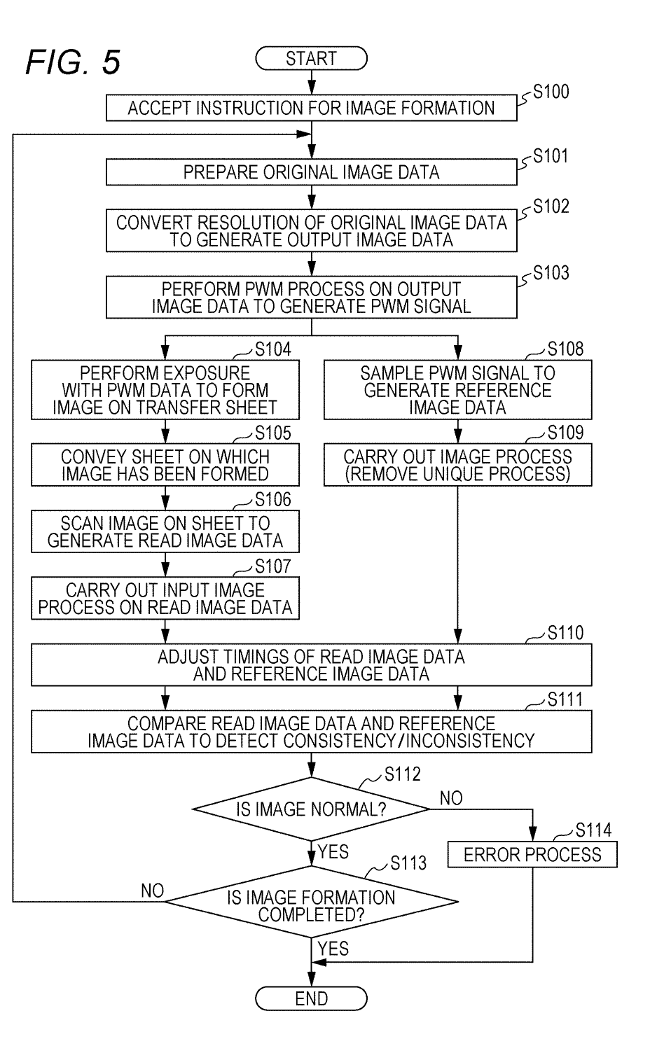

Hereinafter, the action of one or more embodiments will be described with reference to a flowchart in FIG. 5. The following action is implemented by a control program (inspection program) in the controller 101.

In the image forming apparatus 100, the controller 101 accepts an instruction relating to image formation from a user via the operation display 103 or from an external device via a communicator (step S100 in FIG. 5). This instruction relating to image formation includes an instruction to start image formation, designation of image data with which an image is to be formed, designation of a planned cutting area and an image forming area, designation of a post-process, and the like.

The controller 101 as an inspection apparatus may accept a clear instruction to start inspection separately from the instruction to start image formation, or may accept an instruction to start inspection at the same time as image formation is started, or may interpret the instruction to start image formation as an instruction to start inspection.

Once the image data with which an image is to be formed is designated, the controller 101 calls the original image data for forming an image from the designated image data, from the image data storage 110 (step S101 in FIG. 5). The controller 101 converts the original image data into data having a resolution necessary for image formation in the resolution converter 120 to generate output image data (step S102 in FIG. 5).

For example, when the resolution of the original image data is 600 dpi and the image former 140 forms an image at 1200 dpi, the resolution converter 120 executes a resolution conversion process on the original image data of 600 dpi to generate output image data of 1200 dpi.

Furthermore, the controller 101 executes a PWM process on the output image data in the PWM processor 130 to generate a PWM signal having a pulse width according to the pixel value of each pixel, which is an ON/OFF binary pulse (step S103 in FIG. 5).

The controller 101 controls the sheet feeder 105, the conveyer 107, and the image former 140 such that a latent image is formed on a photoconductor by exposure using the PWM signal, the latent image is converted into a toner image in a developer, a sheet is fed from the sheet feeder 105 toward the image former 140, the toner image on the photoconductor is transferred to the conveyed sheet, the toner image on the sheet is fixed by a fixing roller, and a printed material is created (step S104 in FIG. 5).

Then, the controller 101 controls the conveyer 107 such that the printed material thus created through the image formation by the image former 140 is conveyed toward the output object reader 150 (step S105 in FIG. 5).

Once the printed material is conveyed to the output object reader 150 by the conveyer 107, the output object reader 150 controlled by a read signal from the controller 101 reads the printed material being conveyed and generates read image data (step S106 in FIG. 5).

In addition, the output object reader 150 controlled by the controller 101 carries out an input image process for converting the generated read image data of RGB format into data of YMCK format to utilize the converted data as read image data for inspection and sends this read image data for inspection to the inspector 190 (step S107 in FIG. 5).

Meanwhile, the reference image generator 170 samples the binary PWM signal generated by the PWM processor 130 at a predetermined cycle to generate reference image data having a resolution having a predetermined relationship with a resolution of the read image data (step S108 in FIG. 5). The reference image data having the resolution having the predetermined relationship with the resolution of the read image data corresponds to a case where the resolution is equal to that of the read image data, a case where the resolution is an integral multiple or 1/integer of the resolution of the read image data, and the like. That is, the resolution of the reference image data corresponds to the resolution of the read image data.

For example, it is assumed that a PWM signal of 1200 dpi is generated from the above-mentioned output image data of 1200 dpi and read image data of 300 dpi is generated in the output object reader 150. In such a case, the reference image data of 300 dpi can be generated by sampling the PWM signal of 1200 dpi in a main scanning direction and a sub-scanning direction at a quadruple cycle.

In this case, the clock generator 102 supplies an output clock for the process at 1200 dpi to the PWM processor 130 and also generates a reference image clock for the sampling process for 300 dpi by dividing this output clock by four to supply to the reference image generator 170. As for this reference image clock of 300 dpi, the output clock is divided by four in the main scanning direction and at the same time the reference image data is generated at a ratio of one line to four lines of 1200 dpi also in the sub-scanning direction.

That is, the reference image generator 170 samples a PWM signal with binary values of ON and OFF once at every predetermined cycle and generates the reference image data as binary data having a resolution having a predetermined relationship with a resolution of the read image data.

Note that the reference image generator 170 can also produce multivalued reference image data instead of binary reference image data. In such a case, the reference image generator 170 samples a PWM signal with binary values of ON and OFF a plurality of times at every predetermined cycle and uses a plurality of sampling results to generate the reference image data as multivalued data having a resolution having a predetermined relationship with the resolution of the read image data.

For example, in the case of the same resolution as that of the above-mentioned read image data of 300 dpi, the sampler 171 (refer to FIG. 4) samples the PWM signal four times in one cycle for obtaining the 300 dpi and the averager 173 (refer to FIG. 4) averages sampling results for 16 times in total made up of four times in the main scanning direction and four times in the sub-scanning direction to generate one pixel. Through this process, it is possible to generate the reference image data with a resolution of 300 dpi and 16 values from zero to 15 (equivalent to four bits).

In this case, the clock generator 102 supplies an output clock for the process at 1200 dpi to the PWM processor 130 and also supplies the same clock as this output clock to the reference image generator 170 as the reference image clock for the sampling process for 300 dpi and four times.

Note that the clock generator 102 generates the output clock in accordance with the resolution of the PWM signal for the PWM processor 130 and additionally can use the output clock to generate the reference image clock in accordance with the resolution of the reference image data (the same as the resolution of the read image data) and the number of gradations of the reference image data for the reference image generator 170.

When sampling the PWM signal to generate the reference image data, the reference image generator 170 also carries out a necessary predetermined image process (step S109 in FIG. 5). An image process conceivable as the predetermined image process is a process of putting the reference image data into a state close to the read image data and, when there is no abnormality such as dirt or partial loss of the read image data, putting the reference image data and the read image data into a state consistent with each other. In addition, when the unique image process as a countermeasure for thin line is executed in the PWM processor 130 in addition to the PWM process, a process by the unique process remover 172 (refer to FIG. 3) to remove an influence of the unique image process by the PWM processor 130 and generate the reference image data in an initial state, and the like fall under the predetermined image process.

Then, in preparation for inspection in the inspector 190, the timing adjuster 180 controlled by the controller 101 makes a timing of the read image data generated by the output object reader 150 and a timing of the reference image data generated by the reference image generator 170 coincide with each other (step S110 in FIG. 5).

In one or more embodiments, since the reference image data is generated by sampling the PWM signal in the reference image generator 170, a resolution conversion process as in the prior art is not required when the reference image data is generated and the reference image data can be generated in a shorter time than in the past. Actually, the reference image data is generated in the reference image generator 170 faster than image formation by the image former 140 and conveyance of the printed material to the output object reader 150. Therefore, the timing adjuster 180 temporarily stores the reference image data in a data buffer in the timing adjuster 180, the image data storage 110, and the like, so as to make timings of the read image data and the reference image data for arriving at the inspector 190 coincide with each other.

In the timing adjuster 180, the reference image data is written in line with a write signal generated together with the reference image data by the reference image generator 170. Additionally, the timing adjuster 180 is supplied with the read signal supplied to the output object reader 150 and the reference image data is read in line with the read signal. That is, since the same read signal is used, the read image data and the reference image data have a state of timings coincident with each other. This read signal may be generated by the controller 101 or may be emitted by another signal emitter.

Upon receiving an instruction to execute inspection from the controller 101, the inspector 190 compares the timing-adjusted read image data and reference image data to inspect whether these items of data are consistent with each other (step S111 in FIG. 5). In accordance with the execution of image formation by the image former 140 and reading by the output object reader 150 for each line in the main scanning direction, the inspector 190 executes inspection for each line in the main scanning direction. This inspection checks whether inconsistency (abnormality) due to adherence of dirt on the image or chipping of the image or the like has not occurred. In addition, the inspector 190 notifies the controller 101 of an inspection result (consistency/inconsistency).

In response to the inspection result from the inspector 190, the controller 101 counts the number of pixels and the number of lines for which inconsistency has been noticed and, when the count value is equal to or greater than a predetermined threshold value defined in advance, determines that the image is abnormal, while determining that the image is normal when the count value is less than the predetermined threshold value defined in advance (step S112 in FIG. 5). This threshold value may be defined by the user or may be a value preset in advance at the time of manufacturing. In addition, the threshold value may be switched depending on the use of the image and the type of sheet.

When it is determined that the image is normal (YES in step S112 in FIG. 5), the controller 101 repeatedly executes the designated image formation to the final page (NO in step S113 to S101, YES in S113 to end in FIG. 5).

On the other hand, when the number of counts of inconsistency exceeds the threshold value in the inspection of the read image data and the reference image data and it is determined that the image is abnormal (NO in step S112 in FIG. 5), the controller 101 executes an error process due to the occurrence of an abnormality (step S114 in FIG. 5). As this error process, the controller 101 controls such that the respective members of the sheet feeder 105, the conveyer 107, the image data storage 110, the resolution converter 120, the PWM processor 130, and the image former 140 are stopped in order to stop image formation. In addition, the controller 101 displays, on the operation display 103, a message that the image formation is stopped due to abnormality and informs an external device of the stop as necessary. Alternatively, the controller 101 may control the respective members of the sheet feeder 105, the conveyer 107, the image data storage 110, the resolution converter 120, the PWM processor 130, and the image former 140 such that image formation is executed again for the original image data for which an abnormality has been detected, instead of stopping image formation. Also in this case, the controller 101 displays, on the operation display 103, a message that the image formation is re-executed due to abnormality and informs an external device of the fact to the effect as necessary. Since various measures exist as the error process, control other than those indicated here may be executed.

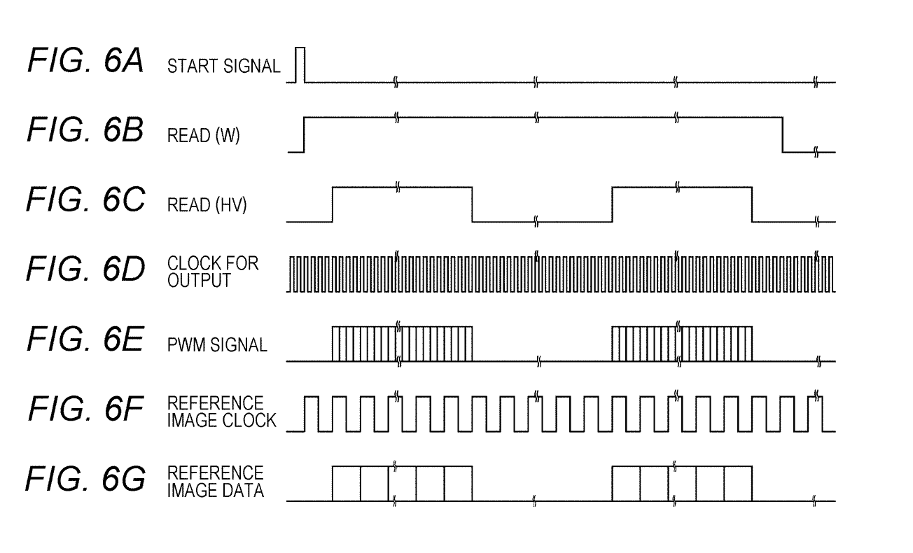

FIGS. 6A to 6G are time charts illustrating the signal timing of each member in the image forming apparatus in the case of generating the binary reference image data illustrated in FIGS. 1 and 2. First, a start signal (FIG. 6A) representing the start of action is given to the controller 101. In response to this start signal, the controller 101 generates a read signal and reads the original image data from the image data storage 110. A vertical valid signal VV (FIG. 6B) indicating a valid timing in the sub-scanning direction of the image and a horizontal valid signal HV (FIG. 6C) indicating a valid timing in the main scanning direction of the image are generated as the above read signal. Meanwhile, the clock generator 102 supplies a clock for output (FIG. 6D; for example, 1200 dpi which is the same as the output image data) for generating the PWM signal, to the PWM processor 130. FIG. 6E schematically illustrates the PWM signal of 1200 dpi. In addition, when the reference image data has 300 dpi and is binary, the clock generator 102 uses the clock for output (FIG. 6D; for example, 1200 dpi) to supply the reference image clock (FIG. 6F; for example, 300 dpi obtained by dividing 1200 dpi by four) to the reference image generator 170. FIG. 6G schematically illustrates the binary reference image data of 300 dpi. This reference image data is read according to the read signal simultaneously with the read image data at the output object reader 150 and the read image data and the reference image data are supplied to the inspector 190.

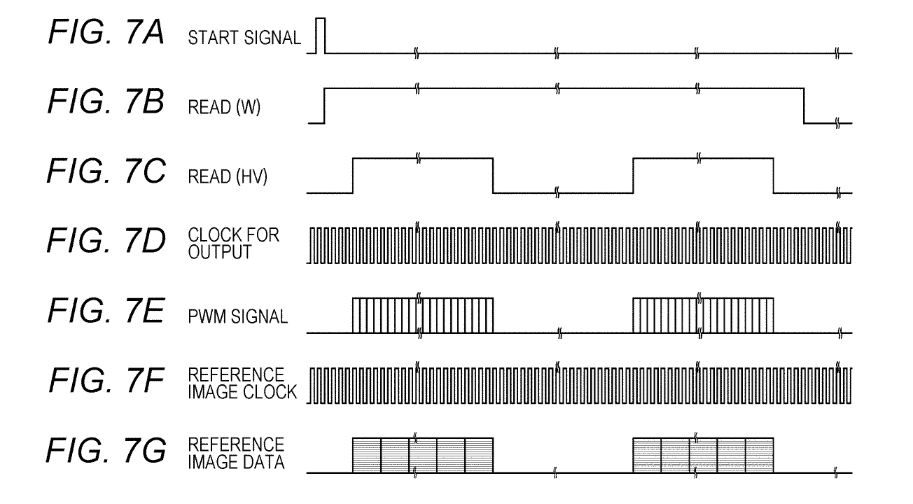

Additionally, FIGS. 7A to 7G are time charts illustrating the signal timing of each member in the image forming apparatus in the case of generating the multivalued (for example, 16-value) reference image data illustrated in FIG. 3. First, a start signal (FIG. 7A) representing the start of action is given to the controller 101. In response to this start signal, the controller 101 generates a read signal and reads the original image data from the image data storage 110. A vertical valid signal VV (FIG. 7B) indicating a valid timing in the sub-scanning direction of the image and a horizontal valid signal HV (FIG. 7C) indicating a valid timing in the main scanning direction of the image are generated as the above read signal. Meanwhile, the clock generator 102 supplies a clock for output (FIG. 7D; for example, 1200 dpi which is the same as the output image data) for generating the PWM signal, to the PWM processor 130. FIG. 7E schematically illustrates the PWM signal of 1200 dpi. In addition, when the reference image data has 300 dpi and 16 values, the clock generator 102 uses the clock for output (FIG. 7D; for example, 1200 dpi) to supply the reference image clock (FIG. 7F; for example, 1200 dpi) to the reference image generator 170. FIG. 7G schematically illustrates the 16-value reference image data of 300 dpi. This reference image data is read according to the read signal simultaneously with the read image data at the output object reader 150 and the read image data and the reference image data are supplied to the inspector 190.

[Specific Examples of Inspection]

A specific example of the inspection in the inspector 190 will be indicated below.

As already described, the inspector 190 checks whether inconsistency (abnormality) due to adherence of dirt on the image or chipping of the image or the like has occurred, for each line in the main scanning direction with respect to the timing-adjusted read image data and reference image data.

Inspection of multivalued and binary data:

In this inspection, in the case of the configuration in FIG. 1, the inspector 190 compares the multivalued read image data and the binary reference image data.

For example, it is possible to acquire a difference between the read image data: ((0 to 255)/255) and the reference image data (0 or 1/1) for each pixel and work out the sum total of the absolute values of these differences for each line or a specific area (several specific lines) or the entire image.

For example, considering four pixels,

when read image data: “16/255, 30/255, 211/255, 232/255” and the reference image data: “0/1, 0/1, 1/1, 1/1” are compared, the sum total of |16/255−0/1|=0.063,|30/255−0/1|=0.118, |211/255−1/1|=0.173, |232/255−1/1|=0.090 are worked out.

Alternatively, with another technique, it is possible to compare the read image data: ((0 to 127), (128 to 255))/255 and the reference image data: (0, 1)/1 and count the number of inconsistent pixels for each line or a specific area (several specific lines) or the entire image.

Actually, various techniques are experimented for the inspector 190 and an appropriate algorithm is applied as a consequence.

Inspection between pieces of multivalued data with different gradation properties:

In this inspection, in the case of the configuration in FIG. 3, the inspector 190 compares the multivalued read image data and the multivalued reference image data with different gradations from those of the read image data.

For example,

it is possible to acquire a difference between the read image data: ((0 to 255)/255) and the reference image data (0 to 15/15) for each pixel and work out the sum total of the absolute values of these differences for each line or a specific area (several specific lines) or the entire image.

For example, considering four pixels,

when read image data: “16/255, 30/255, 211/255, 232/255” and the reference image data: “1/16, 2/16, 14/16, 15/16” are compared, the sum total of |16/255−1/16|=0.000, |30/255−2/16|=0.007, |211/255−14/16|=0.110, |232/255−15/16|=0.028 are worked out.

Alternatively, with another technique, it is possible to compare 256-value read image data: ((0 to 15), (16 to 31), . . . , (240 to 255))/255 and 16-value reference image data: ((0, 1, . . . , 15)/15) and count the number of inconsistent pixels for each line or a specific area (several specific lines) or the entire image.

For example, a correspondence between (16 to 31)/255 and 1/15 results in being coincident and accordingly the difference is given as 0, while a correspondence between (16 to 31)/255 and 2/15 results in being inconsistent and accordingly the difference is given as 1. Such results can be accumulated as the differences.

In this case as well, actually, various techniques are experimented for the inspector 190 and various appropriate algorithms are applied as a consequence.

[Configuration (4)]

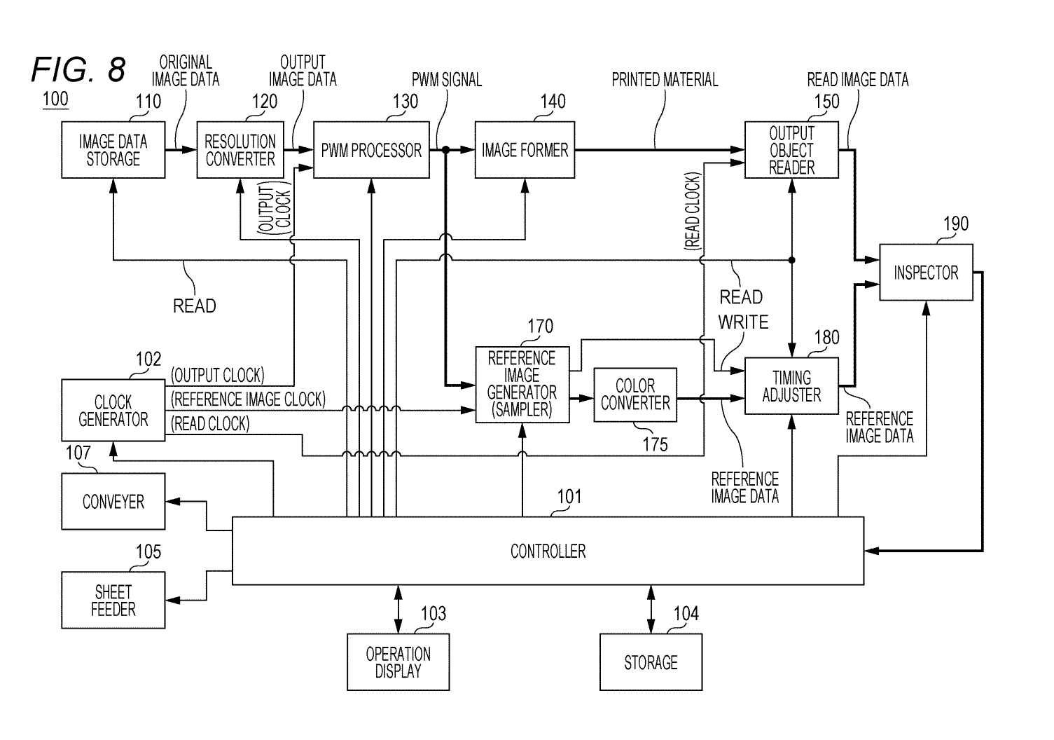

A fourth configuration example of the image forming apparatus 100 including the inspection apparatus will be described in detail with reference to FIG. 8. FIG. 8 is a functional block diagram illustrating the function of each member of each apparatus included in the image forming apparatus 100. In this fourth configuration example of the image forming apparatus 100, the same components as those in the first configuration example to the third configuration example illustrated in FIGS. 1 to 4 are denoted by the same reference numerals and redundant description will be omitted.

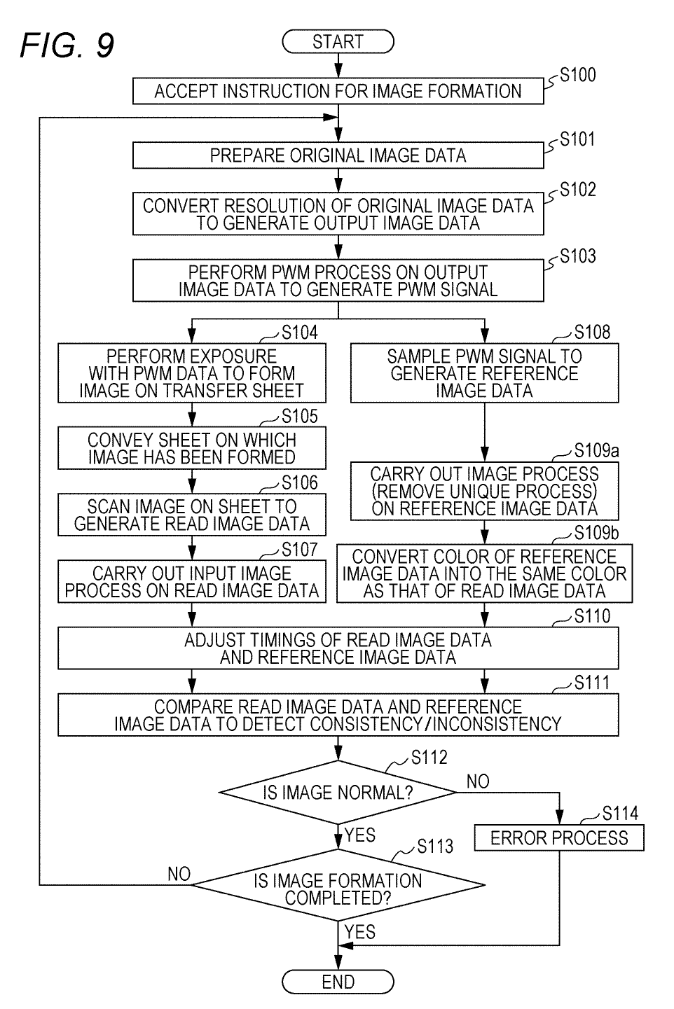

In addition, an operation of the fourth configuration example will be described with reference to a flowchart of FIG. 9. In the flowchart of FIG. 9, the same steps as the process steps already described as the operations of the first configuration example to the third configuration example are denoted by the same step numerals, and redundant description will be omitted.

In FIG. 8, a color converter 175 that carries out color conversion on the reference image data generated by the reference image generator 170 is disposed between the reference image generator 170 and the timing adjuster 180.

The reference image data generated by the reference image generator 170 and the read image data generated by the output object reader 150 may be constituted by different color representations. For example, the reference image data generated by the reference image generator 170 is constituted by a color representation of RGB format, and the read image data generated by the output object reader 150 is constituted by a color representation of YMCK format.

In this case, it is necessary to provide a color converter that executes conversion of the color representation so that any one of the color representation of the reference image data and the color representation of the read image data coincides with the other color representation.

As already described with reference to the flowchart of FIG. 5, the output object reader 150 can also carry out the input image process for converting the generated read image data of RGB format into the data of YMCK format.

By the way, as already described, since the reference image data is generated at a high speed by the sampling rather than the image process for the resolution conversion in the abovementioned embodiments, a margin of a time occurs on the reference image data side until comparison of the inspector 190.

Here, the reference image generator 170 generates the reference image data (step S108 in FIG. 9), and carries out a necessary predetermined image process (step S109a in FIG. 9), and the color converter 175 executes a color conversion process (step S109b in FIG. 9) so that a color representation (for example, YMCK) of the reference image data generated by the reference image generator 170 coincides with a color representation (for example, RGB) of the read image data generated by the output object reader 150.

In this case, a general color conversion referring to a lookup table or the like can be used as the color conversion. In addition, the color converter 175 can execute color conversion of the reference image data side until the comparison of the inspector 190 in a range of the margin of the time described above.

[Configuration (5)]

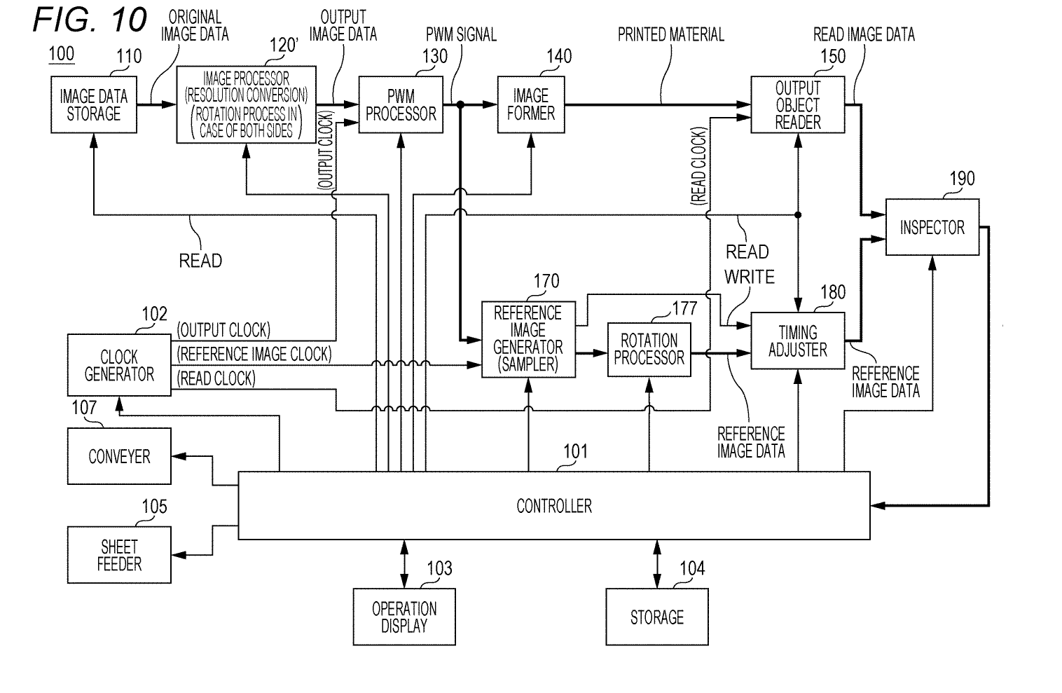

A fifth configuration example of the image forming apparatus 100 including the inspection apparatus will be described in detail with reference to FIG. 10. FIG. 10 is a functional block diagram illustrating the function of each member of each apparatus included in the image forming apparatus 100. In this fifth configuration example of the image forming apparatus 100, the same components as those in the first configuration example to the fourth configuration example are denoted by the same reference numerals and redundant description will be omitted.

When a direction of the reference image data and a direction of the read image data do not coincide with each other on any one of a front side and a back side of the reference image data generated by the reference image generator 170, it is necessary to provide a rotation processor that executes conversion of the direction so that a direction of any one of the reference image data and the read image data coincides with a direction of the other of the reference image data and the read image data. In the fifth configuration example of FIG. 10, a rotation processor 177 that executes the conversion of the direction so that the direction of any one of the reference image data and the read image data coincides with the direction of the other of the reference image data and the read image data is disposed between the reference image generator 170 and the timing adjuster 180.

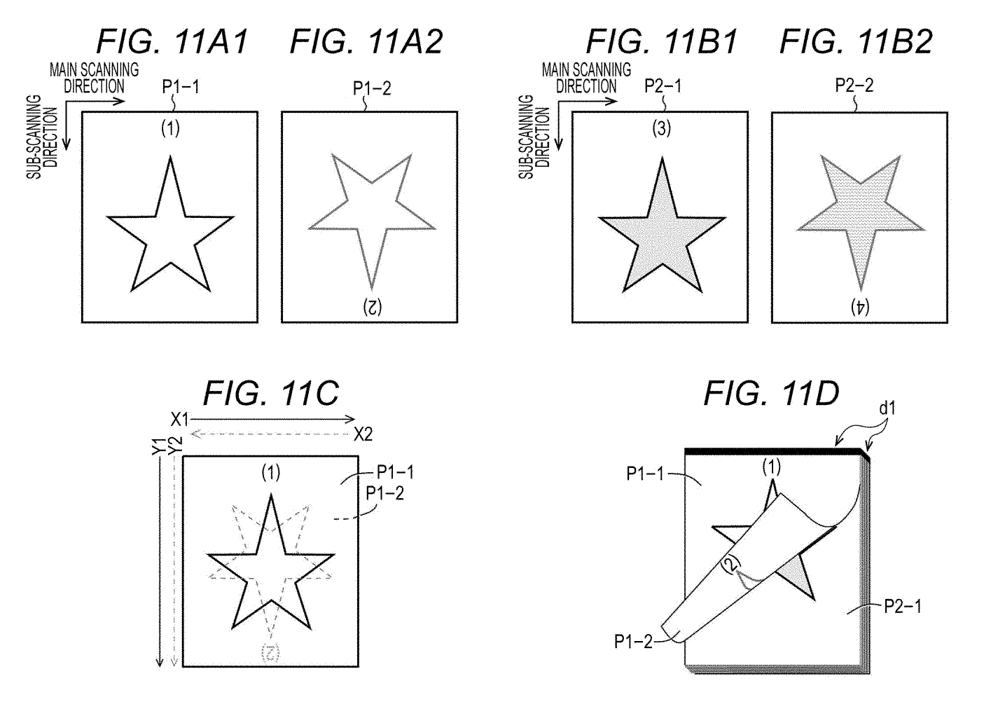

FIGS. 11A to 11G are explanatory diagrams of image formation requiring image rotation and bound books, and illustrate cases where longitudinal images (portrait images) are formed on sheets. In one or more embodiments, it means a format in which when a cover is set to an outer side, short sides of positions above the images on the sheets are bound, and the sheets are opened upward at the time of reading a book made up of a plurality of sheets. Although not illustrated in FIGS. 11A to 11G, a format in which transversal images (landscape images) are formed on the sheets, when a cover is set to an outer side, long sides of positions above the images on the sheets are bound, and the sheets are opened upward at the time of reading a book made up of a plurality of sheets is also possible.

FIG. 11A1 illustrates an image of a first page formed on a first side P1-1 of a first sheet, FIG. 11A2 illustrates an image of a second page formed on a second side P1-2 of the first sheet, FIG. 11B1 illustrates an image of a third page formed on a first side P2-1 of a second sheet, and FIG. 11B2 illustrates an image of a fourth page formed on a second side P2-2 of the second sheet.

Here, an aspect in which the page numbers are attached to upper center positions of each page of portrait sheets is illustrated. When top binding is designated for image formation on the portrait sheets, the image (FIG. 11A2) of the second page formed on the second side P1-2 of the first sheet and the image (FIG. 11B2) of the fourth page formed on the second side P2-2 of the second sheet are formed in a state in which they are rotated from the image (FIG. 11A1) of the first page formed on the first side P1-1 of the first sheet and the image (FIG. 11B1) of the third page formed on the first side P2-1 of the second sheet by 180°, respectively, so that an appearance of each page is in an appropriate state in which short sides of positions above images on the portrait sheets are bound.

FIG. 11D illustrates a sheet bundle bound by adhesion, a staple, or the like, at a position (the same position of each sheet corresponding to a short side of a position above an image of a cover (the first side P1-1 of the first sheet)) d1 above a cover image of the portrait sheets when the cover is set to an outer side, and bound at the top. Here, an image is formed on the first page formed on the first side P1-1 of the first sheet so that a binding position side becomes an upper side, and an image is formed on the second page formed on the second side P1-2 of the first sheet so that an opposite side to the binding position becomes an upper side. Therefore, in a state in which the second side P1-2 of the first sheet is turned toward the binding position, the top and the bottom of the image of the second page are viewed in a normal state. Hereinafter, although not illustrated in FIG. 11D, the same goes for as a third page, a fourth page, a fifth page, a sixth page, and the like.

FIG. 11C schematically illustrates an aspect in which the output object reader 150 reads both sides of the first sheet. With respect to the image (solid line) formed on the first side P1-1 of the first sheet, line-shaped reading in a main scanning direction X1 is repeated in a sub-scanning direction Y1 in accordance with sheet conveyance, on a front side of the sheet. Likewise, with respect to an image (broken line) of a back side formed on the second side P1-2 of the first sheet, simultaneously with the reading of the first side P1-1 of the first sheet described above, line-shaped reading in a main scanning direction X2 is repeated in the sub-scanning direction Y1 in accordance with sheet conveyance, on a back side of the sheet. That is, on the first side and the second side of the sheet, the images in a state in which they are rotated by 180° are read in parallel.

FIG. 11E1 illustrates an image of the first page formed on the first side P1-1 of the first sheet, and FIG. 11E2 illustrates an image of the second page formed on the second side P1-2 of the first sheet. In the image forming apparatus that can form an image up to an A3 size, when the image having the A3 size is formed, the image cannot but be formed in a state of setting directions of the sheet to these directions. Here, the image (FIG. 11E2) of the second page formed on the second side P1-2 of the first sheet is formed in a state in which it is rotated from the image (FIG. 11E1) of the first page formed on the first side P1-1 of the first sheet by 180°. FIG. 11H illustrates a sheet bundle bound by adhesion, a staple, or the like, at a position (the same position (the left in FIG. 11H) of each sheet corresponding to a short side of a position above an image of a cover (the first side P1-1 of the first sheet)) d1 above a cover image of the portrait sheets when the cover is set to an outer side, and bound at the top. FIG. 11C schematically illustrates an aspect in which the output object reader 150 reads both sides of the first sheet. With respect to the image (solid line) formed on the first side P1-1 of the first sheet, line-shaped reading in a main scanning direction X1 is repeated in a sub-scanning direction Y1 in accordance with sheet conveyance, on a front side of the sheet. Likewise, with respect to an image (broken line) of a back side formed on the second side P1-2 of the first sheet, simultaneously with the reading of the first side P1-1 of the first sheet described above, line-shaped reading in a main scanning direction X2 is repeated in the sub-scanning direction Y1 in accordance with sheet conveyance, on a back side of the sheet. That is, on the first side and the second side of the sheet, the images in a state in which they are rotated by 180° are read in parallel.

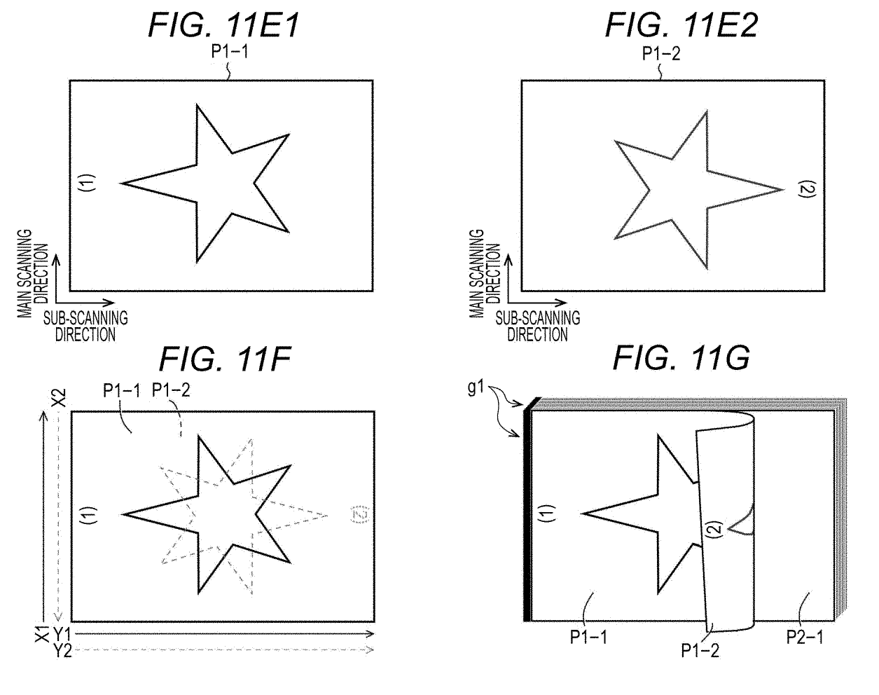

Hereinafter, an operation of the fifth configuration example will be described with reference to a flowchart of FIG. 12. In the flowchart of FIG. 12, the same steps as the process steps already described as the operations of the first configuration example to the fourth configuration example are denoted by the same step numerals, and redundant description will be omitted.

In accordance with image formation (steps S103 and S104 in FIG. 12) on the first side (front side) of the sheet by the image former 140, the reference image generator 170 generates reference image data on the first side of the sheet (step S108a in FIG. 12).

The sheet of which the image formation on the first side has been completed is reversely conveyed by the conveyer 107 and again fed to the image former 140 (YES in step S105a and step S105b in FIG. 12), and in accordance with image formation (steps S103 and S104 in FIG. 12) on the second side (front side) of the sheet by the image former 140, the reference image generator 170 generates reference image data on the second side of the sheet (YES in step S108b, step S108c, and step S108a in FIG. 12).

The sheet of which the image formation on both sides has been completed is conveyed to the output object reader 150 by the conveyer 107 (step S105d in FIG. 12), and the read image data are generated on both sides by the output object reader 150 (step S106 in FIG. 12).

In addition, in the case of image formation for which the top binding is designated (YES in step S109a in FIG. 12), the second side (back side) of the reference image data is processed in a state in which it is rotated by 180° by the rotation processor 177. Therefore, the direction of the reference image data is made to coincide with the direction of the read image data, and it is inspected whether or not the read image data and the reference image data coincide with each other by comparing the read image data and the reference image data (step S111 in FIG. 12).

As a result, even when the direction of the reference image data does not coincide with that of the read image data on any one of the front side and the back side of the reference image data generated by the reference image generator 170, it is possible to quickly inspect whether or not the read image data and the reference image data coincide with each other and identify a source of a problem.

In FIGS. 11A1 to 11G, a case where a document image is an image in a longitudinal direction (portrait sheet), binding is top side (short side) binding, and a direction of reading and comparison is a direction from the top to the bottom of a document (a direction in which the image is reversed) in a sub-scanning direction for a main scanning direction is described by way of example.

However, a case where the reference image data needs to be rotated by 180° is not necessarily limited to the case described above. Also in a case where the document image is an image in a transversal direction, binding is left binding, and a direction of comparison is a direction from the left to the right of the document, the reference image data needs to be rotated by 180°.

In addition, in double-sided printing, when the number of printed materials is 1, the printed material does not need to be necessarily bound, but when a direction of the image or a direction of comparison is the same as that described above, the reference image data needs to be rotated by 180°.

That is, when a direction (a vertical direction of the images) of 0° and 180° of the images on both sides of the sheet is orthogonal to the main scanning direction described above and coincides with the sub-scanning direction described above, since the direction of the read image data and the direction of the reference image data do not coincide with each other in the comparison by the inspector 190 in this state, the reference image data needs to be rotated by 180°. On the other hand, when a direction (a vertical direction of the images) of 0° and 180° of the images on both sides of the sheet is orthogonal to the sub-scanning direction described above and coincides with the main scanning direction described above, since the direction of the read image data and the direction of the reference image data coincide with each other in the comparison by the inspector 190 in this state, and the reference image data does not need to be rotated by 180°.

As already described, since the reference image data is generated at a high speed by the sampling rather than the image process for the resolution conversion in the abovementioned embodiments, a margin of a time occurs on the reference image data side until comparison of the inspector 190. Therefore, the rotation processor 177 can execute correction of the direction of the image until the comparison of the inspector 190 in a range of the margin of the time described above.

[Configuration (6)]

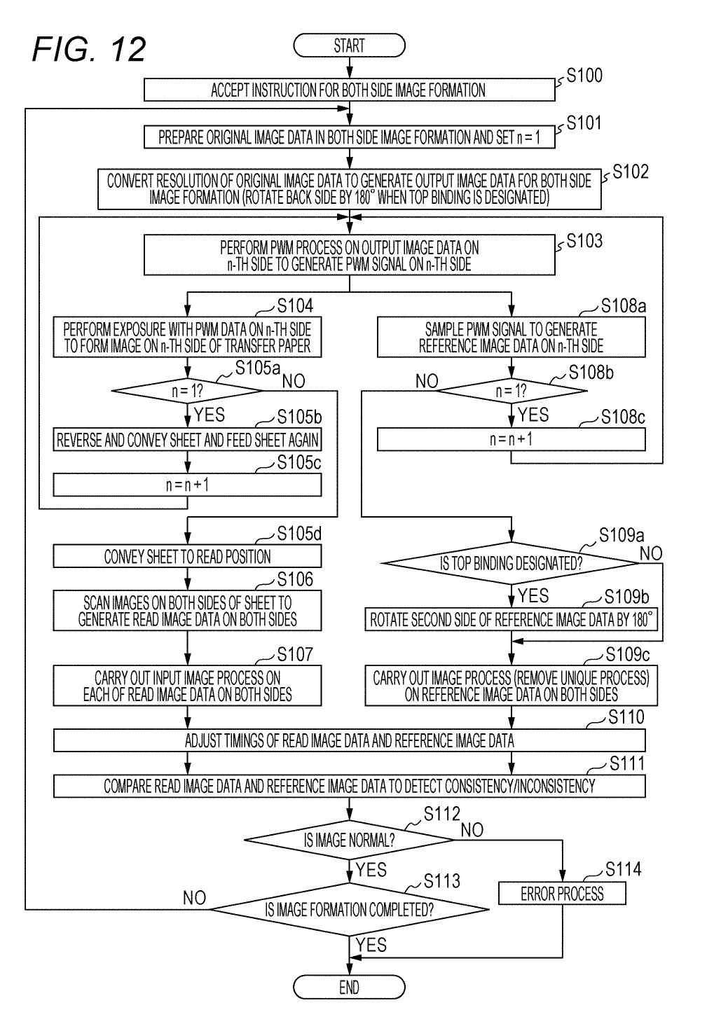

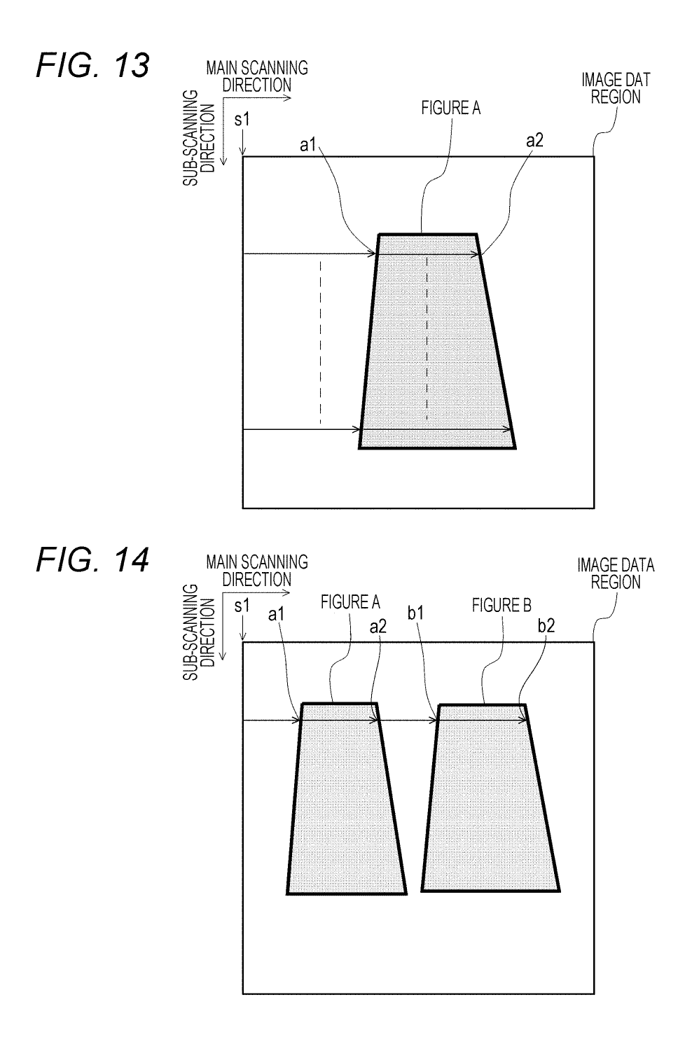

An operation of a sixth configuration example of the image forming apparatus 100 including the inspection apparatus will be described in detail with reference to FIGS. 13 and 14.

Upon receiving an instruction to execute inspection from the controller 101, the inspector 190 generally compares pixels of the timing-adjusted read image data and reference image data to inspect whether the pixels of these data coincide with each other.

In this sixth configuration example, feature points in the image data are determined in advance using an end portion (outer frame) of image data or an end portion (contour) of an image as feature points, corresponding feature points are extracted from the read image data and the reference image data, and positions of the feature points or distances between the feature points of the read image data and the reference image data are compared to inspect a printed material, such that inspection can be quickly conducted.

For example, in FIG. 13, an end portion s1 of an image data area in a main scanning direction, a start side end portion a1 of an image (for example, an aggregate of pixels excluding white or transparent portions) A in the main scanning direction in the image data area, and an end side end portion a2 of the image A in the main scanning direction in the image data area are determined as feature points. In this case, the inspector 190 compares positions of or the respective intervals between the feature points s1, a1, and a2 on the same main scanning line with respect to the timing-adjusted read image data and the reference image data to inspect whether or not the positions of or the respective intervals between the feature points s1, a1, and a2 on the same main scanning line coincide with each other. Therefore, it is unnecessary to conduct inspection on a pixel basis on all the pixels between the read image data and the reference image data, and it is possible to quickly inspect whether or not the read image data and the reference image data coincide with each other and identify a source of a problem.

In addition, for example, in FIG. 14, an end portion s1 of an image data area in a main scanning direction, a start side end portion a1 of an image A in the main scanning direction in the image data area, an end side end portion a2 of the image A in the main scanning direction in the image data area, a start side end portion b1 of an image B in the main scanning direction in the image data area, and an end side end portion b2 of the image B in the main scanning direction in the image data area are determined as feature points. In this case, the inspector 190 compares positions of or the respective intervals between the feature points s1, a1, a2, b1, and b2 on the same main scanning line with respect to the timing-adjusted read image data and the reference image data to inspect whether or not the positions of or the respective intervals between the feature points s1, a1, a2, b1, and b2 on the same main scanning line coincide with each other. Alternatively, the inspector 190 compares positions of or intervals between corresponding contour positions of a plurality of images on the same main scanning line, for example, the feature points a1 and b1 with respect to the timing-adjusted read image data and reference image data to inspect whether or not the positions of or the intervals between the corresponding contour positions coincide with each other. Therefore, it is also possible to further reduce a data processing amount of inspection to realize a speed increase.

In addition, in the sixth configuration example, since comparison is not comparison between pixels, but is comparison between positions or distances, the read image data, which is an inspection target, and the reference image data do not need to have the same resolution, and it is possible to conduct the inspection by calculation by multiplying numerical values of the positions or the distances described above by a coefficient corresponding to a difference between resolutions. In order to be able to easily determine the coefficient at the time of the calculation, it is desirable that the reference image data having a resolution having a predetermined relationship with a resolution of the read image data has the resolution set to an integral multiple or 1/integer of the resolution of the read image data. That is, the resolution of the reference image data corresponds to the resolution of the read image data.

The method of determining the feature points is not limited to the example shown herein, and can be variously modified. For example, it is also possible to extract only pixels having specific colors or pixel values, inspect positions of the pixels or intervals of the pixels from an end portion to further reduce a data processing amount of the inspection, thereby realizing a speed increase.

[Comparison between Conventional Configuration and Configuration of Embodiments]

Hereinafter, the configuration and action of an image forming apparatus 100′ including a conventional inspection apparatus will be described with reference to FIG. 8, in correspondence with the configuration of one or more embodiments illustrated in FIGS. 1 to 4.

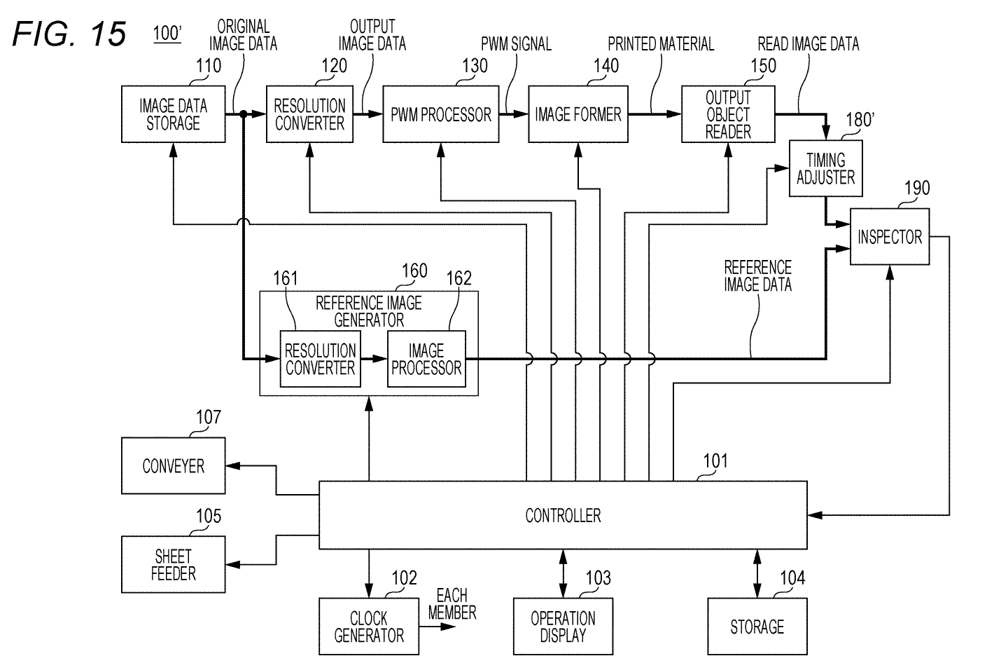

FIG. 15 is a functional block diagram illustrating the function of each member of each apparatus included in the image forming apparatus 100′. In this configuration example of the image forming apparatus 100′, the same components as those in the configuration examples of one or more embodiments illustrated in FIGS. 1 to 4 are denoted by the same reference numerals and redundant description will be omitted.

In this conventional configuration in FIG. 15, a reference image generator 160 converts the resolution of the original image data to generate the reference image data having a resolution equal to that of the read image data. That is, the reference image generator 160 is constituted by a resolution converter 161 that converts the resolution of the original image data and an image processor 162 that carries out a predetermined image process.

In a case where the original image data has 600 dpi and the reading resolution of the scanner is 300 dpi, when the reference image data is generated by the reference image generator 160, the resolution conversion process by the resolution converter 161 converts the original image data of 600 dpi into the reference image data of 300 dpi.

Since this image process for resolution conversion is a two-dimensional image process, a high cost is incurred if the process is executed by hardware, although high speed processing is realized. On the other hand, if the process is executed by software, a longer processing time is required, while cost is satisfactory. Generally, the image process for resolution conversion is frequently executed through software processing, but in this case, since the generation of image data for reference is delayed compared to the generation of the read image data due to a longer time required for the resolution conversion process.

Therefore, a timing adjuster 180′ temporarily saves the read image data and waits for the generation of the reference image data. With this process, inspection (comparison between the read image data and the image data for reference) is not easily implemented in real time. As a result, it is difficult to find an abnormality at the early stage during image formation and stopping the image forming apparatus 100′ is delayed, which leads to a fear of an increase in the number of printed materials having abnormality.

In addition, when an abnormality is discovered in the inspection result of the inspector 190, it is difficult to identify (distinguish) whether the image former 140 has a problem in exposure, transfer, and the like when a printed material is generated, or the image process for resolution conversion to generate the image data for reference by the reference image generator 160 has a problem. In other words, a case where there is no problem at all with the printed material generated by the image former 140 but there is a problem in the reference image data generated through the resolution conversion by the reference image generator 160 is sometimes detected as an abnormality during the inspection by the inspector 190. In such a case, if the action of the image forming apparatus 100′ is stopped, the productivity is unnecessarily lowered.

On the other hand, in the embodiments described above, by sampling the PWM signal at a predetermined cycle to generate the reference image data having a resolution having a predetermined relationship with a resolution of the read image data, the reference image data is smoothly generated earlier than the generation of the read image data at a higher speed than the conventional case of the image process for resolution conversion. In addition, unlike the two-dimensional image process, a simple sampling of the PWM signal which is a binary signal is adopted and no error is supposed to be included in the reference image data. Accordingly, an abnormality in the inspection is directly identified as an abnormality in image formation. Therefore, inspection is quickly and appropriately conducted and a source of a problem is identified with ease.

Furthermore, in the embodiments described above, the PWM signal is sampled at a predetermined cycle to generate the reference image data faster than the read image data and the timing adjuster delays an arrival timing of the reference image data to the inspector 190 to make timings of the read image data and the reference image data coincide with each other, such that the reference image data can be generated and inspected without being late for reading after image formation; consequently, inspection is quickly and appropriately conducted and a source of a problem is identified in a simple manner.

In the embodiments described above, when an image is repeatedly formed in the sub-scanning direction for each line in the main scanning direction based on the PWM signal and the printed material is repeatedly read in the sub-scanning direction for each line in the main scanning direction to generate the read image data, the PWM signal is sampled at a predetermined cycle to generate the reference image data faster than the read image data, the timing adjuster delays the arrival timing of the reference image data to the inspector 190 to make timings of the read image data and the reference image data coincide with each other, and the inspector 190 executes inspection for each line in the main scanning direction, such that the generation of the reference image data and inspection in real time are enabled without being late for reading after image formation; consequently, inspection is quickly and appropriately conducted and a source of a problem is found and identified at an early stage in a simple manner. In addition, in one or more problems, as for the above inspection, the entire image may be inspected on a line basis, or the inspection may be executed selectively on a part of an image area as an area of interest.

Then, by executing the inspection through comparison on a line basis as described above, when an abnormality is detected in any line in one image, a countermeasure for abnormality is immediately started before image formation and reading of the entire area of the one image are completed.

In addition, in the abovementioned embodiments, when the reference image data and the read image data are constituted by different color representations, by making any one of the color representation of the reference image data and the color representation of the read image data coincide with the other color representation, it is possible to appropriately inspect whether or not the read image data and the reference image data coincide with each other and identify a source of a problem. In this case, by executing the conversion of the color expression so that the color representation of the reference image data coincides with the color representation of the read image data, the conversion of the color representation is executed on a sampling side on which a margin occurs in a process time compared to the reading, such that it is possible to quickly inspect whether or not the read image data and the reference image data coincide with each other and identify a source of a problem.

In addition, in the abovementioned embodiment, when the inspection is conducted on a front side and a back side of the printed material, in the case where the direction of the reference image data and the direction of the read image data do not coincide with each other on any one of the front side and the back side, by executing conversion of the direction so that the direction of any one of the reference image data and the read image data coincides with the direction of the other of the reference image data and the read image data, it is possible to appropriately inspect whether or not the read image data and the reference image data coincide with each other and identify a source of a problem. In this case, by executing the conversion of the color expression of the reference image data so that the direction of the reference image data coincides with the direction of the read image data, a rotation process for direction coincidence is executed on a sampling side on which a margin occurs in a process time compared to the reading, such that it is possible to quickly inspect whether or not the read image data and the reference image data coincide with each other and identify a source of a problem.

In addition, in the abovementioned embodiments, by determining the feature points in the image data in advance using the end portion (outer frame) of the image data or the end portion (contour) of the image as the feature points, extracting the corresponding feature points from the read image data and the reference image data, and comparing the positions of the feature points or the distances between the feature points of the read image data and the reference image data, it is unnecessary to conduct inspection on a pixel basis on all the pixels between the read image data and the reference image data, and it is possible to quickly inspect whether or not the read image data and the reference image data coincide with each other and identify a source of a problem.

Numerical values of the resolution and the gradation or timings indicated in the above description are merely examples and various modifications are possible while effective effects of the above embodiments are achieved.

In the above embodiments, a specific example in which the read image data has a lower resolution than that of the PWM signal has been indicated for the sampling of the PWM signal at a predetermined cycle and the generation of the reference image data by the reference image generator 170, but one or more embodiments are not restricted thereto. In other words, the reference image generator 170 may over-sample the low-resolution PWM signal to make the PWM signal coincide with the high-resolution read image data. Also in this case, a better effect than that of the conventional example is achieved by the embodiments.

In the case of a printing format in which different letters and images are formed in a specific area on each sheet as in variable printing, the read image data and the reference image data are compared for several lines included in this specific area to inspect the printed material. By executing the process in this manner, the inspection of the variable printed material is quickly executed and an abnormal printed material is identified, whereby a good result is obtained.

According to one or more embodiments of the present invention, with the inspection apparatus, the image forming apparatus, and the recording medium storing the inspection program, the following effects are achieved.

(1) In the inspection apparatus, the image forming apparatus, and the recording medium storing the inspection program according to one or more embodiments of the present invention, a pulse width modulation (PWM) signal having a pulse width according to a pixel value of each pixel is generated from original image data to generate a printed material in which an image is formed on a sheet, using the PWM signal, the printed material is read to generate read image data, the PWM signal is sampled at a predetermined cycle to generate reference image data having a resolution having a predetermined relationship with a resolution of the read image data, and the printed material is inspected by comparing the read image data and the reference image data.

The PWM signal is sampled at a predetermined cycle to generate the reference image data having the resolution having the predetermined relationship with the resolution of the read image data. The reference image data having the resolution having the predetermined relationship with the resolution of the read image data corresponds to a case where the resolution is equal to that of the read image data, a case where the resolution is an integral multiple or 1/integer of the resolution of the read image data, and the like. Therefore, the reference image data is smoothly generated earlier than the generation of the read image data at a higher speed than the case of the image process for the resolution conversion. In addition, unlike the two-dimensional image process, a simple sampling of the PWM signal in which a binary signal is adopted and no error is supposed to be included in the reference image data. Accordingly, an abnormality in the inspection is directly identified as an abnormality in image formation. Therefore, an inspection apparatus, an image forming apparatus, and a recording medium storing an inspection program capable of quickly and appropriately conducting inspection and identifying a source of a problem can be implemented.

(2) In the above (1), a PWM signal having a pulse width according to a pixel value of each pixel from original image data is generated, a printed material in which an image is formed on a sheet using the PWM signal is generated, the printed material is read to generate read image data, the PWM signal is sampled at a predetermined cycle to generate reference image data having a resolution equal to a resolution of the read image data, and the printed material is inspect by comparing the read image data and the reference image data. By sampling the PWM signal at a predetermined cycle to generate the reference image data with a resolution equal to a resolution of the read image data, the reference image data is smoothly generated earlier than the generation of the read image data at a higher speed than the case of the image process for resolution conversion. In addition, unlike the two-dimensional image process, a simple sampling of the PWM signal which is a binary signal is adopted and no error is supposed to be included in the reference image data. Accordingly, an abnormality in the inspection is directly identified as an abnormality in image formation. Therefore, an inspection apparatus, an image forming apparatus, and a recording medium storing an inspection program capable of quickly and appropriately conducting inspection and identifying a source of a problem can be implemented.

(3) In the above (1) and (2), when the reference image data and the read image data are constituted by different color representations, by making any one of the color representation of the reference image data and the color representation of the read image data coincide with the other color representation, it is possible to appropriately inspect whether or not the read image data and the reference image data coincide with each other and identify a problem.

(4) In the above (3), when the reference image data and the read image data are constituted by the different color representations, conversion of a color representation is executed so that the color representation of the reference image data coincides with the color representation of the read image data. Therefore, the conversion of the color representation is executed on a sampling side on which a margin occurs in a process time compared to the reading, such that it is possible to quickly inspect whether or not the read image data and the reference image data coincide with each other and identify a source of a problem.

(5) In the above (1) to (4), when the inspection is conducted on a front side and a back side of the printed material, in the case where the direction of the reference image data and the direction of the read image data do not coincide with each other on any one of the front side and the back side, by executing conversion of the direction so that the direction of any one of the reference image data and the read image data coincides with the direction of the other of the reference image data and the read image data, it is possible to appropriately inspect whether or not the read image data and the reference image data coincide with each other and identify a source of a problem.

(6) In the above (5), in the case where the direction of the reference image data and the direction of the read image data do not coincide with each other, by executing conversion of the direction so that the direction of the reference image data coincides with the direction of the read image data. Therefore, the rotation process for the direction coincidence is executed on a sampling side on which a margin occurs in a process time compared to the reading, such that it is possible to quickly inspect whether or not the read image data and the reference image data coincide with each other and identify a source of a problem.

(7) In the above (1) to (5), by determining the feature points in the image data in advance using the end portion (outer frame) of the image data or the end portion (contour) of the image as the feature points, extracting the corresponding feature points from the read image data and the reference image data, and inspecting the printed material by comparing the positions of the feature points or the distances between the feature points of the read image data and the reference image data, it is unnecessary to conduct inspection on a pixel basis on all the pixels between the read image data and the reference image data, and it is possible to quickly inspect whether or not the read image data and the reference image data coincide with each other and identify a source of a problem.

(8) In the above (1) to (7), a PWM signal with binary values of ON and OFF is sampled once at every predetermined cycle and the reference image data is generated as binary data, such that the reference image data can be generated as binary data having a resolution having a predetermined relationship with a resolution of the read image data at high speed without errors; consequently, the inspection apparatus, the image forming apparatus, and the recording medium storing the inspection program capable of quickly and appropriately conducting inspection and identifying a source of a problem are implemented.

(9) In the above (1) to (8), a PWM signal with binary values of ON and OFF is sampled a plurality of times at every predetermined cycle and the reference image data is generated as multivalued data having a resolution having a predetermined relationship with a resolution of the read image data using a plurality of sampling results, such that multivalued reference image data can be generated at high speed without errors; consequently, the inspection apparatus, the image forming apparatus, and the recording medium storing the inspection program capable of quickly and appropriately conducting inspection and identifying a source of a problem are implemented.

(10) In the above (1) to (9), a clock signal when a reference image generator samples the PWM signal is generated by referring to a clock signal used for generating the PWM signal, such that appropriate reference image data can be generated and inspected by appropriate sampling; consequently, the inspection apparatus, the image forming apparatus, and the recording medium storing the inspection program capable of quickly and appropriately conducting inspection and identifying a source of a problem are implemented.

(11) In the above (1) to (10), a timing adjuster delays an arrival timing of the reference image data to an inspector to make timings of the read image data and the reference image data coincide with each other, such that the reference image data can be generated and inspected without being late for reading after image formation; consequently, the inspection apparatus, the image forming apparatus, and the recording medium storing the inspection program capable of quickly and appropriately conducting inspection and identifying a source of a problem are implemented. Therefore, when an image is formed for each line in a main scanning direction and the read image data is generated for each line, comparison for each specific area and comparison on a line basis are enabled by making timings of the read image data and the reference image data coincide with each other, such that an abnormal printed material can be found at an early stage.

(12) In the above (11), the timing adjuster uses a timing signal with which the read image data is generated, to make timings of the read image data and the reference image data coincide with each other, such that the reference image data can be reliably generated and inspected without being late for reading after image formation; consequently, the inspection apparatus, the image forming apparatus, and the recording medium storing the inspection program capable of quickly and appropriately conducting inspection and identifying a source of a problem are implemented. Therefore, when an image is formed for each line in a main scanning direction and the read image data is generated for each line, comparison for each specific area and comparison on a line basis are enabled by making timings of the read image data and the reference image data coincide with each other, such that an abnormal printed material can be found at an early stage.

(13) In the above (11) and (12), when an image is repeatedly formed in a sub-scanning direction for each line in the main scanning direction based on the PWM signal and a printed material is repeatedly read in the sub-scanning direction for each line in the main scanning direction to generate read image data, a timing of the reference image data is adjusted and the read image data and the reference image data are compared and inspected for each line in the main scanning direction, such that inspection in real time is enabled without being late for reading after image formation; consequently, the inspection apparatus, the image forming apparatus, and the recording medium storing the inspection program capable of quickly and appropriately conducting inspection and finding a source of a problem to identify at an early stage are implemented.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An inspection apparatus that handles a printed material in which an image is formed on a sheet by a pulse width modulation (PWM) signal having a pulse width according to a pixel value of each pixel of original image data, the inspection apparatus comprising:
a reference image generator that samples the PWM signal and generates the reference image data that serve as a criterion as a comparison target in inspection; and
an inspector that inspects the printed material by comparing read image data obtained by reading the printed material and the reference image data.

2. The inspection apparatus according to claim 1, wherein the reference image generator samples the PWM signal at a predetermined cycle and generates the reference image data that has a resolution equal to a resolution of the read image data.

3. The inspection apparatus according to claim 1, further comprising a color converter that executes conversion of one of a color representation of the reference image data and a color representation of the read image data to coincide with the other color representation when the reference image data and the read image data are constituted by different color representations.

4. The inspection apparatus according to claim 3, wherein the color converter executes conversion of the color representation of the reference image data to coincide with the color representation of the read image data.

5. The inspection apparatus according to claim 1, further comprising a rotation processor that executes conversion of a direction of any one of the reference image data and the read image data to coincide with a direction of the other of the reference image data and the read image data in the case where the direction of the reference image data and the direction of the read image data do not coincide with each other on any one of a front side and a back side of the printed material, when the inspection is conducted on the front side and the back side of the printed material.

6. The inspection apparatus according to claim 5, wherein the rotation processor executes conversion of a direction of the reference image data to coincide with the direction of the read image data.

7. The inspection apparatus according to claim 1, wherein the inspector inspects the printed material by determining feature points in image data in advance, extracting the corresponding feature points from the read image data and the reference image data, and comparing positions of the corresponding feature points or distances between the feature points of the read image data and the reference image data.

8. The inspection apparatus according to claim 1, wherein the reference image generator samples the PWM signal with binary values of ON and OFF once per the predetermined cycle and generates the reference image data as binary data having a corresponding resolution to a resolution of the read image data.

9. The inspection apparatus according to claim 1, wherein the reference image generator samples the PWM signal with binary values of ON and OFF a plurality of times per the predetermined cycle and uses a plurality of sampling results to generate the reference image data as multivalued data having a corresponding resolution to a resolution of the read image data.

10. The inspection apparatus according to claim 1, further comprising a clock generator that generates a clock signal when the reference image generator samples the PWM signal, by referring to a clock signal used for generating the PWM signal.

11. The inspection apparatus according to claim 1, further comprising a timing adjuster that delays an arrival timing to the inspector of the reference image data generated by the reference image generator to make timings of the read image data and the reference image data coincide with each other, wherein
the inspector compares the read image data and the reference image data whose timings have been adjusted by the timing adjuster, to inspect the printed material.

12. The inspection apparatus according to claim 11, wherein the timing adjuster uses a timing signal used for generating the read image data, to make timings of the read image data and the reference image data coincide with each other.

13. The inspection apparatus according to claim 11, wherein:
when the image is repeatedly formed in a sub-scanning direction for each line in a main scanning direction based on the PWM signal and the printed material is repeatedly read in the sub-scanning direction for each line in the main scanning direction to generate the read image data,
the inspector compares the read image data and the reference image data whose timings have been adjusted by the timing adjuster for each line to inspect the printed material.

14. An image forming apparatus comprising:
an image former that generates a PWM signal having a pulse width according to a pixel value of each pixel from original image data and generates a printed material in which an image is formed on a sheet using the PWM signal;
a reader that reads the printed material and generates read image data; and
the inspection apparatus according to claim 1.

15. A non-transitory computer readable recording medium storing an inspection program that controls an inspection apparatus that comprises a reference image generator and an inspector, and that handles a printed material in which an image is formed on a sheet by a PWM signal having a pulse width according to a pixel value of each pixel of original image data, the inspection program controlling a computer of the inspection apparatus to execute:
sampling, by the reference image generator, the PWM signal and generating the reference image data that serve as a criterion as a comparison target in inspection; and
inspecting, by the inspector, the printed material by comparing read image data obtained by reading the printed material and the reference image data.

16. A non-transitory computer readable recording medium storing an inspection program that controls an image forming apparatus that comprises an image former, a reader, a reference image generator, and an inspector, and that handles a printed material in which an image is formed on a sheet by a PWM signal having a pulse width according to a pixel value of each pixel of original image data, the inspection program controlling a computer of the image forming apparatus to execute:
generating, by the image former, a PWM signal having a pulse width according to a pixel value of each pixel from original image data, and generating a printed material in which an image is formed on a sheet using the PWM signal;
reading, by the reader, the printed material and generating read image data obtained by reading the printed material;
sampling, by the reference image generator, the PWM signal and generating the reference image data that serve as a criterion as a comparison target in inspection; and
inspecting, by the inspector, the printed material by comparing the read image data and the reference image data.

17. The non-transitory computer readable recording medium storing inspection program according to claim 15, wherein:
the PWM signal is sampled at a predetermined cycle; and
the reference image data has a resolution equal to a resolution of the read image data.
